(19) United States
(12) Patent Application Publication
(10) Pub. No.: US 2004/0215367 A1
(43) Pub. Date: Oct. 28, 2004

(54) Method and apparatus supporting container identification for multiple quay cranes

(76) Inventors: Henry S. King, Moraga, CA (US); Toru Takehara, San Mateo, CA (US)

Correspondence Address: GREGORY SMITH & ASSOCIATES, 3900 NEWPARK MALL ROAD, 3RD FLOOR, NEWARK, CA, 94560, US

(21) Appl. No.: 10/850,935

(22) Filed: May 21, 2004

Related U.S. Application Data
(63) Continuation-in-part of application No. 10/120,032, filed on Apr. 9, 2002, now Pat. No. 6,768,931.
(63) Continuation-in-part of application No. PCT/US01/24458, filed on Aug. 2, 2001.
(63) Continuation of application No. 09/632,866, filed on Aug. 4, 2000, now Pat. No. 6,356,802.

(51) Int. Cl. G06F 7/00

(52) U.S. Cl. 700/225; 414/140.3; 414/141.3; 414/142.6

(57) ABSTRACT

Aspects of the invention include a container code recognition system and method for each of at least two quay cranes. At least one image frame sequence for a container viewed by a camera, on each of the quay cranes, is provided to a human operator. The human operator responds to the image frame sequence for the container. Receiving the human response creates a container code for the container handled by each quay crane. The human response may be through use of a keyboard, pointing device, acoustic interface, and/or eye movement.

The invention further includes at least one image frame of the image frame sequence, as well as, the container code for the container as products of the invention's process. Further, the process products may include an identification of the quay crane and/or a time-stamp. The time-stamp may either be when the quay crane transfer occurs and/or when the human operator responds.

A container inventory management system may receive one or more of the invention's process products, which may be used to update the system.

Archival items generated by the invention's process include the container code, the image frame, further preferably include the quay crane identification and at least one time-stamp.

### CROSS REFERENCES TO PRIORITY DOCUMENTS

This application is a continuation-in-part of U.S. Ser. No. 10/120,032 filed Apr. 9, 2002, and incorporates by reference PCT patent application Ser. No. PCT/US01/24458 filed Aug. 2, 2001 and U.S. Ser. No: 09/632,866 filed Aug. 4, 2000, now issued as U.S. Pat. No. 6,356,802. The applicant hereby incorporates by reference in their entirely all of the patents and patent applications listed above

### FIELD OF THE INVENTION

The present invention relates to container code recognition of cargo containers during loading and unloading by quay side cranes.

### BACKGROUND INFORMATION

Container terminals are transfer points between marine and land-based shipping. These container terminals must maintain inventory control for an ever-increasing number of containers. Each of these container terminals operates under significant legal constraints, either, through contracts, with vendors, labor unions, or through government laws and mandates. These constraints limit the kinds of improvements to the inventory control processes and systems. They also limit the implementation of these improvements.

The point of transfer between marine transport and land-based transport is the quay side crane, or quay cranes, as they will be known hereafter. Transfer operations will refer to transferring containers between a container ship and a land transport by one of these quay cranes.

During the unloading of a container ship, a human clerk confirms the container code of each transferred container against the list of containers and their locations on the ship, known as the ship manifest. The transferring of a container typically takes between 90 and 150 seconds, and today typically involves one full-time clerk, who is active less than 15 to 30 seconds of that time recognizing the container code. What is needed is a way to increase the productivity of human clerks confirming the ship manifests.

The container code is the only universally required form of identification. The container is visually present on several sides of every container. Keeping track of the container and its contents requires confirming the container code. If the clerk cannot confirm the container code, the clerk notifies the crane operator to place the container aside for closer inspection. This is a disruptive process. That container cannot enter the terminal storage yard until confirmation of its container code. There is an economic advantage to minimizing the number of unconfirmed container codes. These unconfirmed containers also pose a security risk, the containers are already on dry land with unknown cargo weighing up to several tons.

A second clerk enters the confirmation of the ship manifest to update the container inventory management system of the terminal. The entry process can take many hours, because there are often thousands of containers loaded and unloaded for a single ship. Until the entry is completed, terminal management does not know where the containers are, or even whether they have all arrived. There is a need to quickly update the terminal container inventory management system.

Today, long lasting records are not made of the visual condition of transferred containers. Today, there is no standard procedure to notify terminal management of a visibly damaged container. There is a need to inspect the containers and/or create these records at the time of transfer for several reasons.

The clerks may incorrectly confirm a container code, and/or incorrectly update the container inventory management system. A record of both the visual appearance of the container code on the container, the container code as confirmed and as entered into the container inventory management system, can help identify discrepancies.

Damaged containers may lead to lawsuits and insurance claims against the terminal management. Damage may occur to a container before arriving at the terminal, at the terminal, or after leaving the terminal. Inspecting these containers can identify visibly damaged containers and help pinpoint responsibility.

A similar process is involved in loading containers onto ships. The invention applies to both loading and unloading operations by quay cranes.

The containers transferred by a quay crane often weigh many tons, and mishaps with these containers can create dangerous accidents in the quay crane vicinity. For this reason, the fewer people near a quay crane, the fewer possibilities for dangerous accidents. This may lead to lower insurance premiums for a terminal. There are safety and insurance advantages to minimizing the number of personnel working near quay cranes.

Today clerks typically use a clipboard and a printed ship manifest for confirming containers. The clerk confirms the container code by circling that code on the printed ship manifest. A second clerk then types the confirmations into a computer, which is part of the container inventory management system. In many terminals, there are pay scale rules for clerks, making it more expensive if the clerks use a keyboard, as opposed to pen on paper, pen computer tablet, or voice interface. Additionally, repetitive use of a keyboard tends to create job related health problems, which are both painful for the sufferers, and a cause for insurance claims.

To summarize, there is a need for a container code recognition system, which increases the productivity and accuracy of human clerks confirming the transfer of containers by quay cranes. The container inventory management system of a terminal needs updating quickly. There are economic and security advantages to minimizing the number of unconfirmed container codes. There is often a need to inspect the containers and/or create long lasting records of the visual condition of the containers and the container codes as recognized at the time of transfer. There are advantages to minimizing the number of personnel working near quay cranes. There are also advantages to minimizing the use of keyboards by clerks and the number of clerks.

### BRIEF SUMMARY OF THE INVENTION

Aspects of the invention address the various needs for recognizing the container code for containers handled by quay cranes in transfer operations.

Aspects of the invention include a container code recognition system and method for each of at least two quay cranes. At least one image frame sequence for a container viewed by a camera, on each of the quay cranes, is provided to a human operator. The human operator responds to the image frame sequence for the container. Receiving the human response creates a container code for the container handled by each quay crane. The human response may be through use of a keyboard, pointing device, acoustic interface, and/or eye movement.

The invention further includes at least one image frame of the image frame sequence, as well as, the container code for the container as products of the invention's process. At least one of the products of the process may further include an identification of the quay crane and/or a time-stamp. The time-stamp may either be when the quay crane transfer occurs and/or when the human operator responds.

In certain aspects of the invention, a container inventory management system may receive one or more of these products, which may be used to update the system.

Archival items generated by the invention's process preferably include the quay crane identification and at least one time-stamp. The archival items may help deter fraud and assist in insurance claim processing. The archival items are also products of the process.

The human operator may further direct at least one the cameras in at least one of the following ways: a zoom direction and a pan direction. The zoom and pan directions are useful for resolving the container codes. Lighting may illuminate the containers.

### BRIEF DESCRIPTION OF THE DRAWINGS

FIG. 1A shows a simplified system block diagram including two quay cranes, a human operating, viewing, and responding to an example system updating the container inventory management system of a container terminal;

FIG. 1B shows the transfer operation collection;

FIG. 2 shows an alternative to the example system of FIG. 1A;

FIG. 3A shows the program system of FIG. 2;

FIG. 3B shows the program system of FIGS. 2 and 3A supporting further operations;

FIGS. 4A and 4B show detail flowcharts of FIG. 3A;

FIG. 5A shows a detail of the communications interface on a quay crane in FIG. 2;

FIG. 5B shows one example embodiment of the display and interface of FIG. 2;

FIG. 5C shows the display and interface of FIG. 2 with more than one display;

FIG. 6A shows a detail flowchart of receiving from the human operator of FIGS. 1A, 2, and 3A;

FIG. 6B shows a detail flowchart of FIG. 6A;

FIG. 7A shows a detail flowchart of sending the container code of FIG. 3A;

FIGS. 7B and 7C show examples of the container update messages of FIG. 2;

FIGS. 7D and 7E show examples of the archival items of FIG. 2;

FIG. 8A shows a further aspect of the invention's method of operation of FIG. 2;

FIG. 8B shows sending to the container manage inventory system of FIGS. 2 and 3A;

FIGS. 8C to 9B show further aspects of the inventions method of FIGS. 2 and 3A;

FIG. 10A shows the camera direction collection;

FIG. 10B shows the zoom directive collection;

FIG. 10C shows the pan directive collection;

FIG. 10D shows the lighting directive collection.

### DESCRIPTION OF THE PREFERRED EMBODIMENTS

Aspects of the invention address the various needs for recognizing container codes for containers handled by quay cranes in transfer operations.

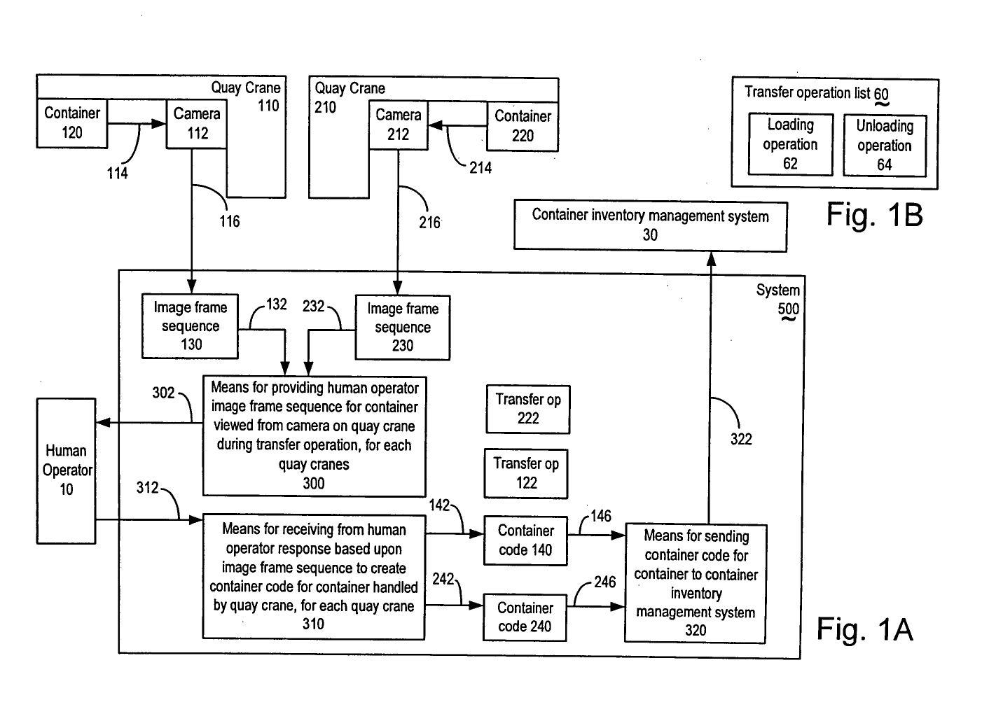

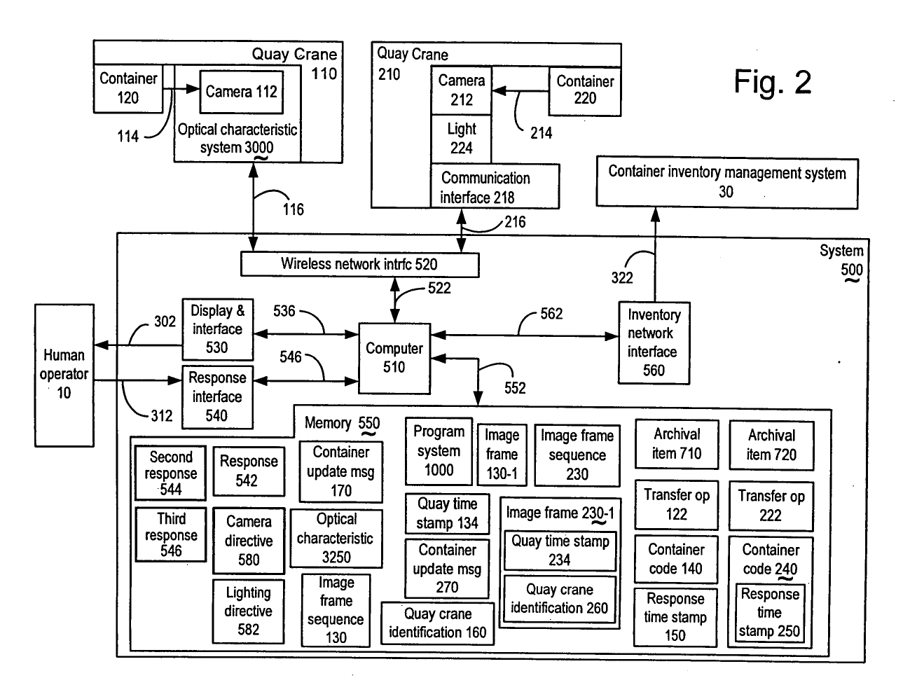

Aspects of the invention include a container code recognition system 1000 as in FIGS. 1A and 2, for containers 120, transferred 122 by the quay crane 110, and container 220 transferred 222 by the quay crane 210. A human operator 10 is provided 302 image frame sequences 130 and 230 for containers 120 and 220. The human operator, responding 312 to the image frame sequences 130 and 230, creates the container codes 140 and 240. The container codes 140 and 240 are then sent 322 to the container inventory management system 30.

The transfer operations 122 and 222 of FIGS. 1A and 2 may be sent from the container inventory management system 30 to the system 1000. The quay cranes 110 and 210 may report the transfer operations. The human operator 10 may determine the transfer operations based upon the image frame sequences 130 and 230.

The transfer operations 122 and 222 of FIG. 1A are members of the transfer operation collection 60 of FIG. 1B, which includes a loading operation 62 and an unloading operation 64.

FIG. 1A shows means 300 providing 302 a human operator 10 with image frame sequences 130 and 230 for containers 120 and 220 viewed by cameras 112 and 212 on the quay cranes 110 and 210. Means 310 receives 312 the human operator 10 response, based upon 132 and 232 the image frame sequences 130 and 230 for containers 120 and 220, respectively. Means 310 creates 142 and 242 container codes 140 and 240 for container 120 and 220 handled by each of the quay cranes 110 and 210. Means 320 sends container codes 140 and 240 to 322 container inventory management system 30.

FIG. 2 shows communicative coupling 116 between an optical characteristic system 3000 and a wireless network interface 520. The optical characteristic system 3000 operates the camera 116, providing the image frame sequence 230, and preferably providing optical characteristic 3250. The optical characteristic system 3000 uses optical character recognition to generate the optical characteristic 3250.

The communicative coupling 216 of FIGS. 1A and 2 may use a wireline physical transport or, preferably, at least one wireless physical transport. The communicative coupling 322 with the container inventory management system may or may not be distinct from either or both of the couplings 116 and 216. In certain aspects of the invention, the container inventory management system may preferably use a separate, wireline network.

FIG. 2 shows lights 230 as well as camera 216, both communicatively coupled 216 via communication interface 218 with wireless network interface 520. Under certain conditions and for some aspects of the invention, the lights 230 preferably operate with the camera 216 for viewing 214 container 220 on quay crane 210 during a transfer operation 222.

The computer 510 in FIG. 2 is communicatively coupled 546 with the response interface 540, which receives 312 the response of the human operator 10. The human response may be through use of a keyboard, pointing device, acoustic interface, and/or eye movement.

The computer 510 in FIG. 2 is communicatively coupled 536 with the display and interface 530 which provides 532 the image frame sequences 130 and 230 to the human operator 10.

The computer 510 in FIG. 2 is communicatively coupled 522 with the wireless network interface 520. The computer 510 is also communicatively coupled 562 to the inventory network interface 560.

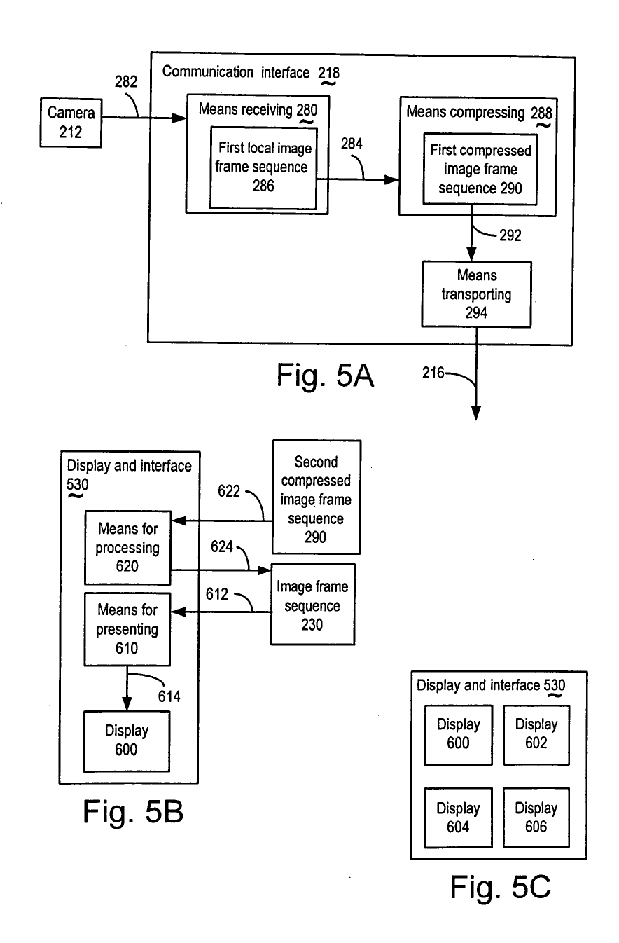

The communications interface 218 of FIG. 2 may preferably include the following as shown in FIG. 5A. Means 280 for receiving from 282 the camera 212 a first image frame sequence 286. Means 288 for generating a compressed image frame sequence 290 based upon 284 the first image frame sequence 286. Means 294 for transporting the compressed image frame sequence 290 to create a compressed sequence within the system 1000 as shown in FIG. 5B. The image frame sequences are preferably motion image sequences. In general, the image frames are provided at least at a rate of one frame per second.

The compressed image frame sequences may include a sequence of compressed still frames, or a compressed motion video frame sequence. The first approach today tends to use JPEG compression. The compressed motion video frame sequence may be a form of MPEG.

The program system 1000 in FIG. 2 implements the method of operating the invention's apparatus using program steps residing in memory 550, which is accessed 552 by computer 510 to direct the performance of the method's operations.

Some of the following figures show flowcharts of at least one method of the invention, possessing arrows with reference numbers. These arrows may signify the flow of control and sometimes data, supporting implementations including at least one program operation or program thread executing upon a computer, inferential links in an inferential engine, state transitions in a finite state machine, and learned responses within a neural network.

The operation of starting a flowchart refers to at least one of the following. Entering a subroutine in a macro instruction sequence in a computer. Entering into a deeper node of an inferential graph. Directing a state transition in a finite state machine, possibly while pushing a return state. And triggering a collection of neurons in a neural network.

The operation of termination in a flowchart refers to at least one or more of the following. The completion of those operations, which may result in a subroutine return, traversal of a higher node in an inferential graph, popping of a previously stored state in a finite state machine, return to dormancy of the firing neurons of the neural network.

A computer as used herein will include, but is not limited to an instruction processor. The instruction processor includes at least one instruction processing element and at least one data processing element, each data processing element controlled by at least one instruction processing element.

The operation in a flowchart refers to at least one of the following. The instruction processor responds to the operation as a program step to control the data execution unit in at least partly, implementing the operation. The inferential engine responds to the operation as nodes and transitions within the inferential graph based upon and modifying an inference database in at least partly implementing the operation. The neural network responds to the operation as stimulus in at least partly, implementing the operation. The finite state machine responds to the operation as at least one member of a finite state collection comprising a state and a state transition, implementing at least partly, the operation.

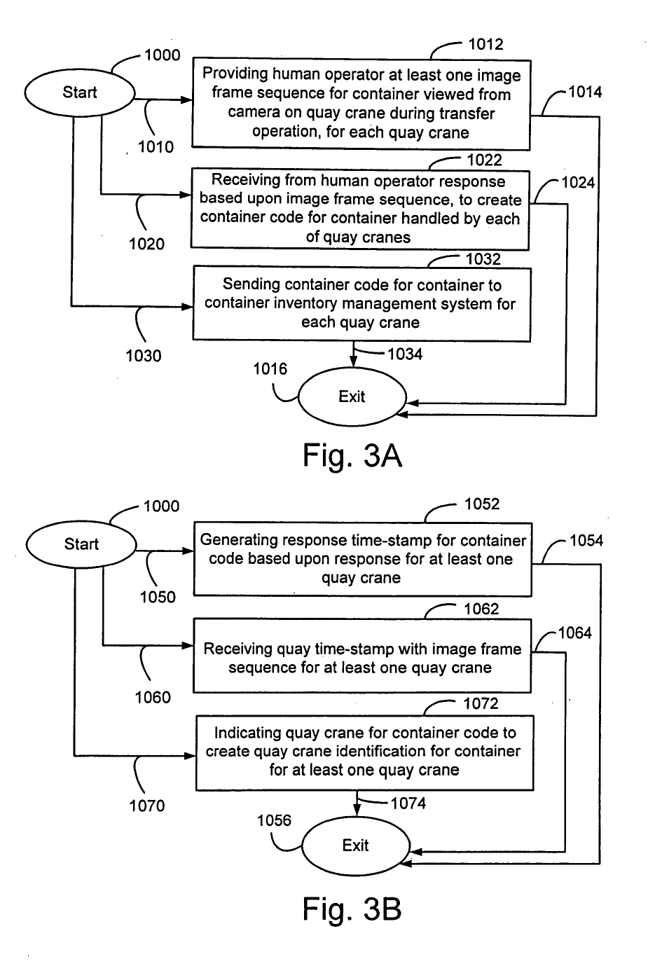

FIG. 3A shows the method of operating the system 500 of FIGS. 1A and 2, as program steps within the program system 1000 of FIG. 2. Operation 1012 supports providing the human operator at least one image frame sequence for the container viewed from the camera on the quay crane during a transfer operation, for each of the quay cranes. Operation 1022 supports receiving from the human operator a response based upon the image frame sequence to create the container code for the container handled by the quay crane, for each of the quay cranes. Operation 1032 supports sending the container code for the container to the container inventory management system, for each of the quay cranes.

The method shown in FIG. 3A and subsequent Figures may be implemented as means for performing these operations. The means may include at least one computer controlled at least in part by a program system comprising at least one program step residing in a memory accessibly coupled to the computer. The program step at least partially implements the operation. The computer includes at least one member of a collection comprising an instruction processor, an inferential engine, a neural network, and a finite state machine. The instruction processor includes at least one instruction processing element and at least one data processing element, wherein each of the data processing elements is controlled by at least one of the instruction processing elements.

FIG. 3B shows the program system 1000 of FIGS. 2 and 3A supporting at least one of the following operations. Operation 1052 supports generating a response time-stamp 150 for the container code 140 based upon the response 542 for at least one of the quay cranes 110. Operation 1062 supports receiving a quay time-stamp 134 with the image frame sequence 130 for at least one of the quay cranes 110. Operation 1072 supports indicating the quay crane 210 for the container code 240 to create a quay crane identification 260 for the container 220, for at least one of the quay cranes 210.

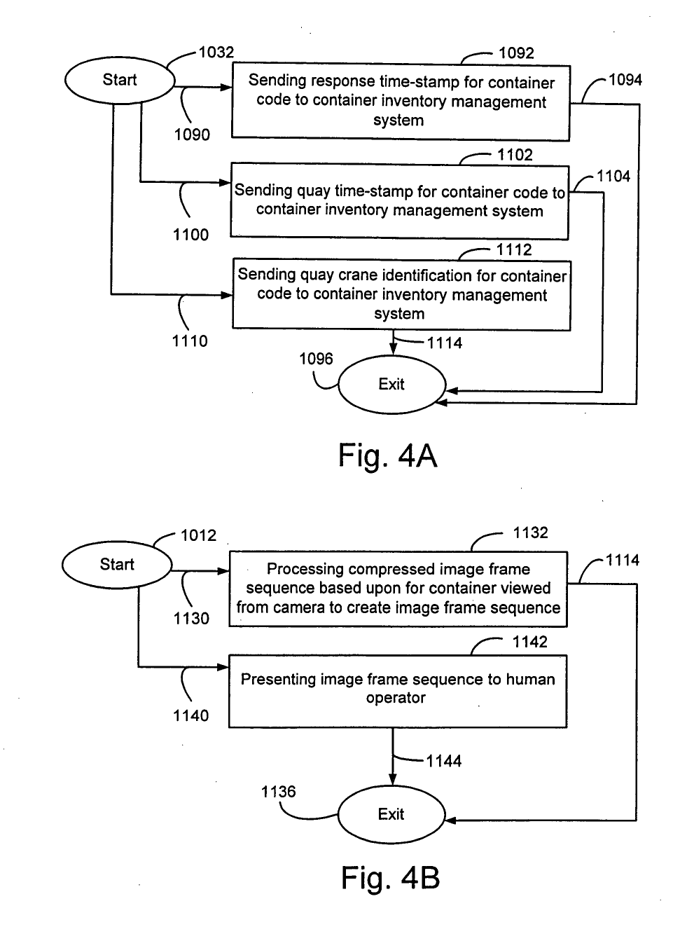

FIG. 4A shows a detail flowchart of operation 1032 of FIG. 3A including at least one of the following. Operation 1092 supports sending the response time-stamp for the container code to the container inventory management system. Operation 1102 supports sending the quay time-stamp for the container code to the container inventory management system. Operation 1112 supports sending the quay crane identification for the container code to the container inventory management system.

FIG. 4B shows a refinement of operation 1012 of FIG. 3A, supporting the receipt of a compressed image frame sequence 290 as shown in FIGS. 5A and 5B. Operation 1132 supports processing a compressed image frame sequence 290 based upon the container 220 viewed from the camera 212 on the quay crane 210 during the transfer operation 222 to create the image frame sequence 230 of FIG. 2. Operation 1142 supports presenting the image frame sequence to the human operator.

FIG. 5B shows an alternative, often preferred, embodiment of the display and interface 530 of FIG. 2, for at least one of the quay cranes, including the following. Means 620 for processing a compressed image frame sequence 290 for the container 210 viewed from the camera 212 on the quay crane 210 during the transfer operation 222 to create the image frame sequence 230. Means 610 for presenting the image frame sequence 230 preferably drives 614 at least one display 600 for presentation to the human operator 10. In certain aspects of the invention, the display and interface 530 preferably includes a graphics accelerator circuit driving one or more displays 600, and may include means 610 and/or means 620.

Aspects of the invention may include more than one display as shown in FIG. 5C, where the display and interface 530 of FIGS. 2 and 5B includes four displays 600, 602, 604, and 606. This example may be preferred in certain situations, where N, the number of quay cranes providing image frame sequences, is at least two. In certain aspects of the invention, N is preferably at most four.

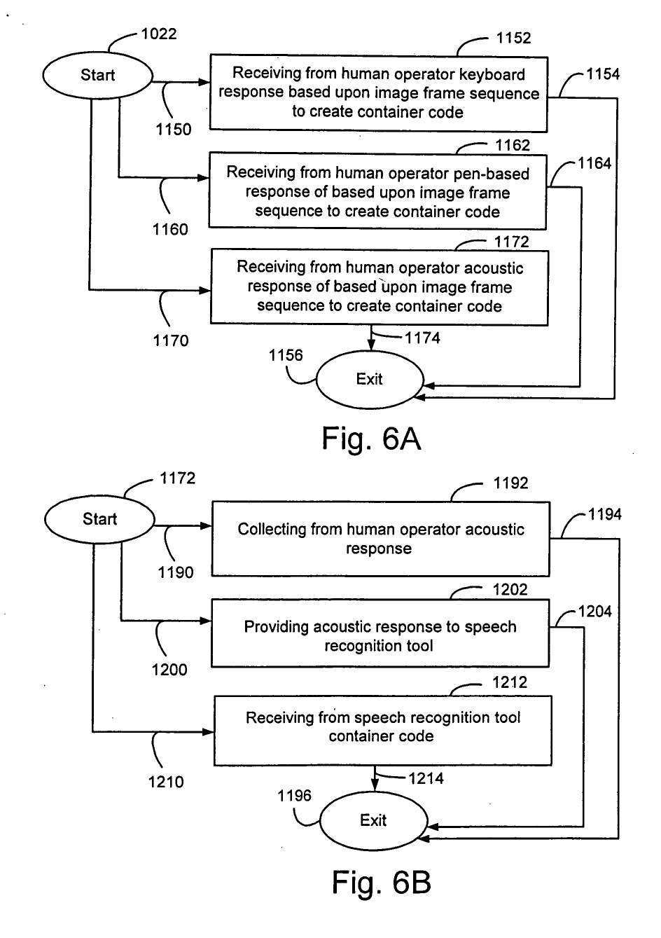

The operation 1022, as in FIG. 3A, of receiving from the human operator 10 the response of FIGS. 1A and 2, may further include at least one of the following operations shown in FIG. 6A. Operation 1152 supports receiving 312 from the human operator 10 a keyboard response based upon the image frame sequence to create the container code. Operation 1162 supports receiving 312 from the human operator 10 a pen-based response based upon the image frame sequence to create the container code. Operation 1172 supports receiving from the human operator an acoustic response based upon the image frame sequence to create the container code.

FIG. 6B shows a detail of operation 1172 of FIG. 6A. Operation 1192 supports collecting from the human operator the acoustic response. Operation 1202 supports providing the acoustic response to a speech recognition tool. Operation 1212 supports receiving from the speech recognition tool the container code.

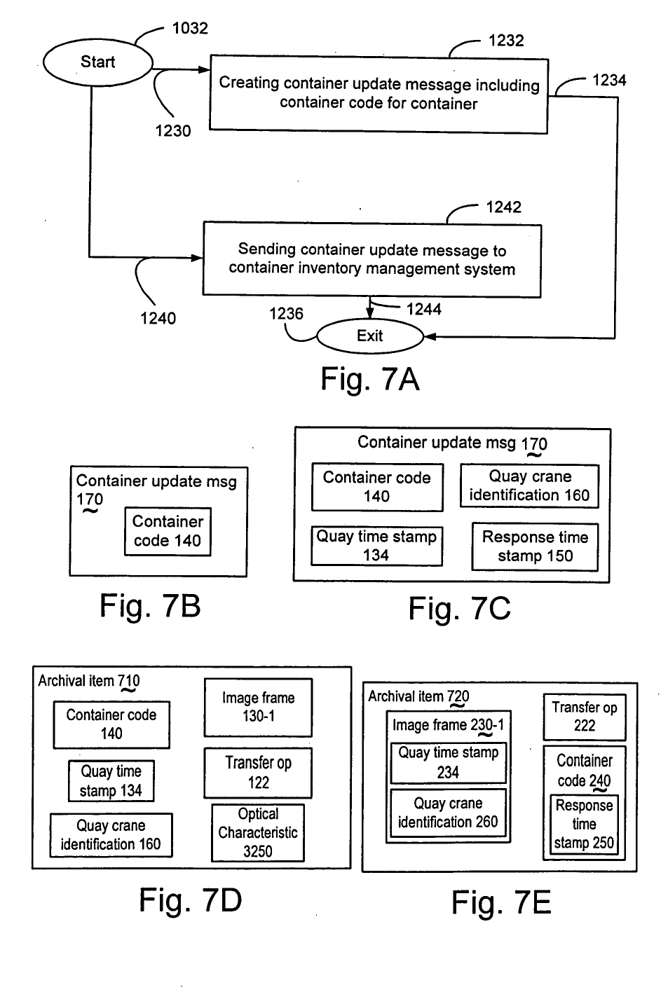

FIG. 7A shows a detail flowchart of operation 1032 of FIG. 3A. Operation 1232 supports creating a container update message including the container code for the container. Operation 1242 supports sending the container update message to the container inventory management system.

FIGS. 7B and 7C show examples of the container update message 170 of FIG. 2. The container code 140 is included in both examples. Container update messages may further include one or more of the following shown in FIG. 7C, the quay crane identification 160, the quay time stamp 134, and the response time stamp 150.

FIGS. 7D and 7E show examples of the archival items 710 and 720 of FIG. 2, respectively.

In FIG. 7D, the archival item 710 includes the container code 140 and the image frame 130-1 of FIG. 2. Archival item 710 may further, preferably include: the quay time stamp 134, the quay crane identification 160, the response time stamp 150, the transfer operation 122, and the optical characteristic 3250 generated by the optical characteristic system 3000.

In FIG. 7E, the archival item 720 preferably includes the container code 240 with the response time stamp 250, and the image frame 230-2, further including the quay time stamp 234 and the quay crane identification 260 of FIG. 2. Archival item 720 further, preferably includes the transfer operation 222.

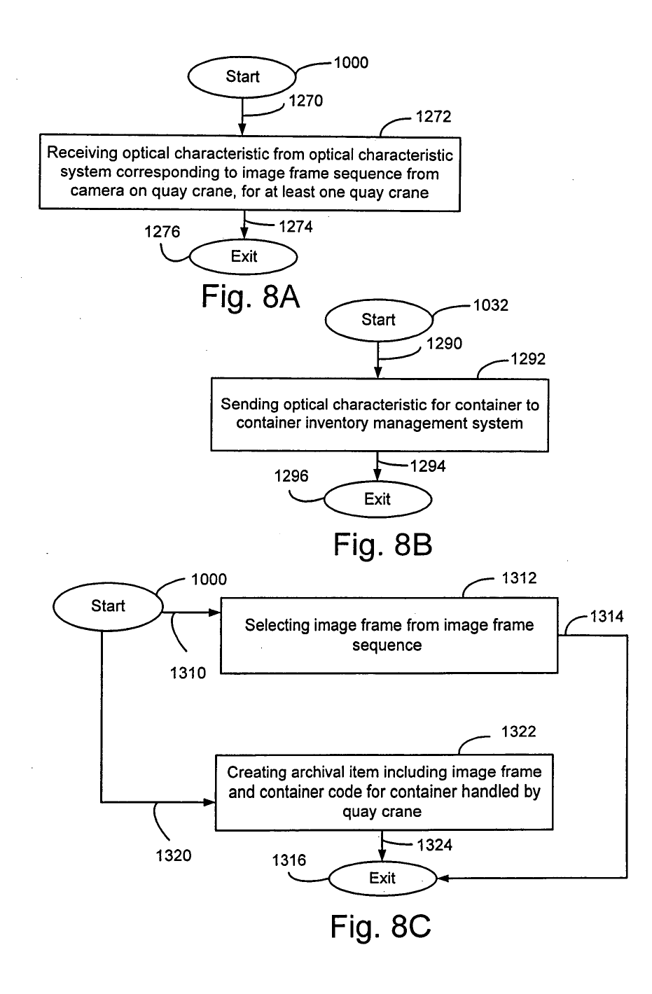

FIG. 8A shows a further aspect of the invention's method of operation 1000 of FIG. 2. Operation 1272 supports receiving an optical characteristic 3250 from an optical characteristic system 3000 corresponding to the image frame sequence 130 from the camera 112 on the quay crane 110, for at least one of the quay cranes.

FIG. 8B shows a detail flowchart of operation 1032 of FIG. 3A. Operation 1292 supports sending the optical characteristic 3250 for the container 120 to the container inventory management system 30.

FIG. 8C shows a further aspect of the inventions method 1000 of FIG. 2, for at least one of the quay cranes. Operation 1312 supports selecting an image frame 130-1 from the image frame sequence 130. Operation 1322 supports creating an archival item 710 including the image frame 130-1 and the container code 140 for the container 120 handled by the quay crane 110. When an optical characteristic system 3000 is available, as on quay crane 110 of FIG. 2, it may be further preferred that creating 1322 the archival item include the optical characteristic 3250, as shown in FIG. 7D.

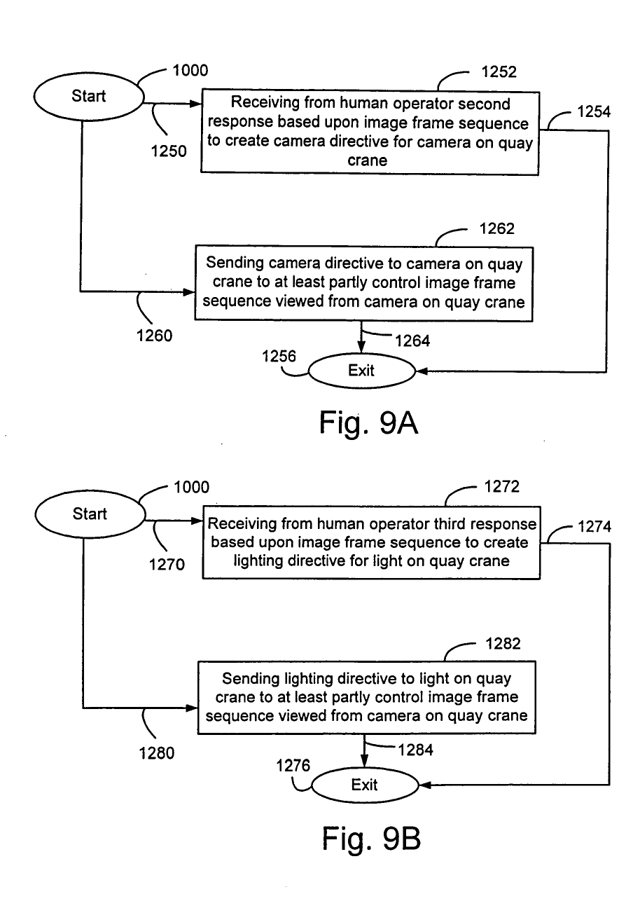

FIG. 9A shows a further detail flowchart of the method of operation 1000 of FIG. 2. Operation 1252 supports receiving from 312 the human operator 10 a second response 542 based upon the image frame sequence 230, to create a camera directive 580 for the camera 212 on the quay crane 210. Operation 1262 supports sending the camera directive 580 to 216 the camera 212 on the quay crane 210 to at least partly control the image frame sequence 230 viewed from the camera 212 on the quay crane 210.

When at least one light 230 directed to the container 220 is mounted near the quay crane 210 as in FIG. 2, the method of operation 1000 may further preferably include the operations of FIG. 9B. Operation 1272 supports receiving from the human operator 10 a third response 542 based upon the image frame sequence 230, to create a lighting directive 582 for the light 230 on the quay crane 210. Operation 1282 supports sending the lighting directive 582 to the light 230 on the quay crane 210, to at least partly control, the image frame sequence 230 viewed from the camera 212 on the quay crane.

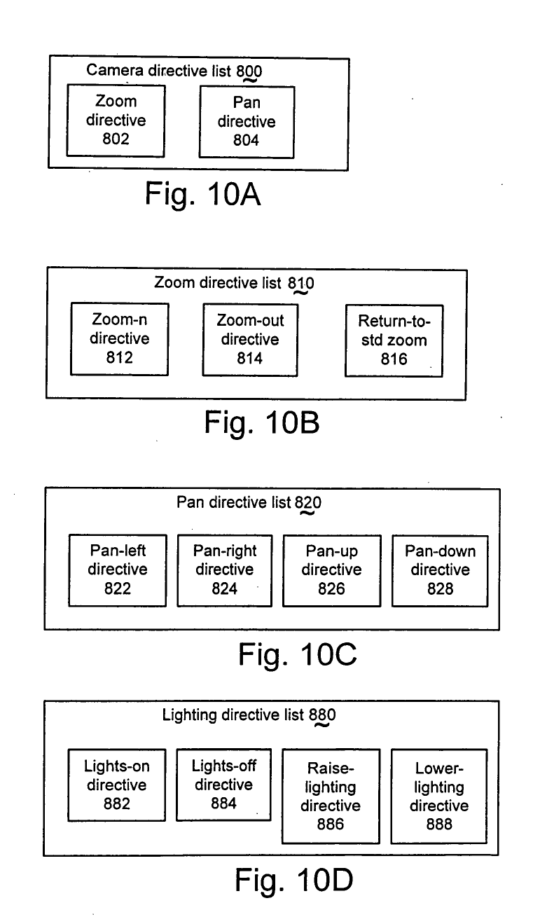

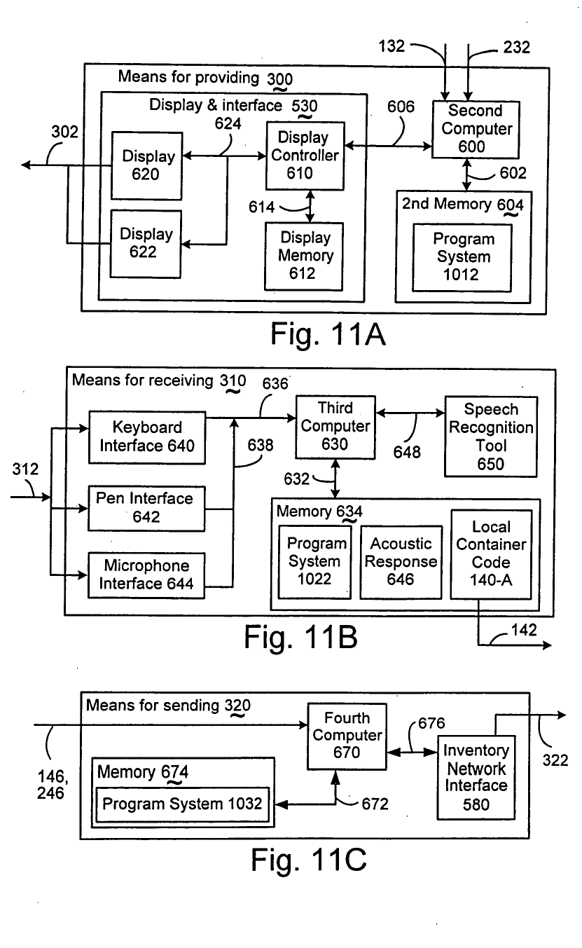

The camera directive 580 of FIGS. 2 and 9A includes at least one member of a camera directive collection 800, as shown in FIG. 10A, comprising a zoom directive 802 and a pan directive 804.

The zoom directive 802 of FIG. 10A is a member of a zoom directive collection 810, shown in FIG. 10B, including at least one zoom-in directive 812, at least one zoom-out directive 814, and a return-to-standard zoom directive 816.

The pan directive 804 of FIG. 10A is a member of a pan directive collection 820, shown in FIG. 10C, including a pan-left directive 822, a pan-right directive 824, a pan-up directive 826 and a pan-down directive 828.

The lighting directive 582 of FIGS. 2 and 9B includes at least one member of a lighting directive collection 880, shown in FIG. 10D. The lighting directive collection includes a lights-on directive 882, a lights-off directive 884, a raise-lighting directive 886, and a lower-lighting directive 888.

Those skilled in the art will appreciate that various adaptations and modifications of the just-described preferred embodiments have been provided by way of example and are not meant to constrain the scope of the following claims.

1. A apparatus updating a container inventory management system for a container handled by a quay crane, for each of at least N of said quay cranes, comprising:
a computer communicatively coupled with at least one camera on said quay crane, for each of said quay cranes, and with said container inventory management system;
said computer accessibly coupled to a memory;
said computer interactively coupled with a human operator;
wherein said computer is at least partly controlled by a program system including program steps residing in said memory;
wherein said program system is comprised of the program steps of:
providing said human operator at least one image frame sequence for said container viewed from said camera on said quay crane during a transfer operation, for each of said quay cranes;
receiving from said human operator, a response based upon said image frame sequence, to create said container code for said container handled by said quay crane, for each of said quay cranes; and
sending said container code for said container to said container inventory management system, for each of said quay cranes;
wherein said transfer operation is a member of a transfer operation collection comprising a loading operation and an unloading operation;
wherein said N is at least two.

2. The apparatus of claim 1, wherein said program system further comprising, at least one member of the collection comprising the program steps of:
generating a response time-stamp for said container code based upon said response, for at least one of said quay cranes;
receiving a quay time-stamp with said image frame sequence, for at least one of said quay cranes; and
indicating said quay crane for said container code to create a quay crane identification for said container, for at least one of said quay cranes; and
wherein the program step sending said container code further comprises at least one member of the collection comprising the program steps of:
sending said response time-stamp for said container code to said container inventory management system;
sending said quay time-stamp for said container code to said container inventory management system; and
sending said quay crane identification for said container code to said container inventory management system.

3. The apparatus of claim 1, wherein said computer interactively coupled with said human operator, for at least one of said quay cranes, further comprising:
means for processing a compressed image frame sequence based upon said container viewed from said camera on said quay crane during said transfer operation to create said image frame sequence; and
means for presenting said image frame sequence to said human operator.

4. The apparatus of claim 1, wherein the program step receiving from said human operator said response further comprising at least one member of the collection comprising the program steps of:
receiving from said human operator a keyboard response based upon said image frame sequence to create said container code;
receiving from said human operator a pen-based response based upon said image frame sequence to create said container code; and
receiving from said human operator an acoustic response based upon said image frame sequence to create said container code.

5. The apparatus of claim 4, wherein the program step receiving from said human operator said acoustic response further comprising the program steps:
collecting from said human operator said acoustic response;
providing said acoustic response to a speech recognition tool; and
receiving from said speech recognition tool said container code.

6. The apparatus of claim 1, wherein the program step sending said container code further comprising the program steps of:
creating a container update message including said container code for said container; and
sending said container update message to said container inventory management system.

7. The apparatus of claim 6, wherein said container update message further includes at least one member of the collection comprising:
an identification of said quay crane,
a response time-stamp based upon said response, and
a quay time-stamp received with said image frame sequence.

8. The apparatus of claim 1, wherein said program system further comprising the program steps of:
receiving an optical characteristic from an optical characteristic system corresponding to said image frame sequence from said camera on said quay crane, for at least one of said quay cranes;
wherein the program step sending said container code further comprising the program step of:
sending said optical characteristic for said container to said container inventory management system.

9. The apparatus of claim 8, wherein said program system, for at least one of said quay cranes, further comprising the program steps of:
selecting an image frame from said image frame sequence; and
creating an archival item including said image frame and said container code for said container handled by said quay crane and including said optical characteristic.

10. The apparatus of claim 1, said program step, for at least one of said quay cranes, further comprising the program steps of:
selecting an image frame from said image frame sequence; and
creating an archival item including said image frame and said container code for said container handled by said quay crane.

11. The apparatus of claim 10, wherein said archival item further includes at least one member of the collection comprising:
an identification of said quay crane,
a response time-stamp based upon said response, and
a quay time-stamp received with said image frame sequence.

12. The apparatus of claim 1, wherein said computer includes at least one member of a collection comprising an instruction processor, an inferential engine, a neural network, and a finite state machine;
wherein said instruction processor includes at least one instruction processing element and at least one data processing element; wherein each of said data processing elements is controlled by at least one of said instruction processing elements.

13. The apparatus of claim 1, wherein said program system further comprises, for at least one of said cameras on at least one of said quay cranes, the program steps of:
receiving from said human operator a second response based upon said image frame sequence, to create a camera directive for said camera on said quay crane; and
sending said camera directive to said camera on said quay crane to at least partly control said image frame sequence viewed from said camera on said quay crane;
wherein said camera directive includes at least one member of a camera directive collection comprising a zoom directive and a pan directive;
wherein said zoom directive is a member of a zoom directive collection comprising at least one zoom-in directive, at least one zoom-out directive, and a return-to-standard zoom directive;
wherein said pan directive is a member of a pan directive collection comprising a pan-left directive, a pan-right directive, a pan-up directive and a pan-down directive.

14. The apparatus of claim 1, wherein, for at least one of said quay cranes, at least one light directed to said container is mounted near said quay crane;
wherein said program system is further comprising the program steps of:
receiving from said human operator a third response based upon said image frame sequence, to create a lighting directive for said light on said quay crane; and
sending said lighting directive to said light on said quay crane to at least partly control said image frame sequence viewed from said camera on said quay crane; and
wherein said lighting directive includes at least one member of a lighting directive collection comprising a lights-on directive, a lights-off directive, a raise-lighting directive, and a lower-lighting directive.

15. A method of updating a container inventory management system for a container handled by a quay crane, for each of at least N of said quay cranes, comprising the steps of:
providing a human operator at least one image frame sequence for said container viewed from at least one camera on said quay crane during a transfer operation, for each of said quay cranes;
receiving from said human operator, a response based upon said image frame sequence, to create said container code for said container handled by said quay crane, for each of said quay cranes; and
sending said container code for said container involved in said transfer operation to said container inventory management system, for each of said quay cranes;
wherein said N is at least two;
wherein said transfer operation is a member of a transfer operation collection comprising a loading operation and an unloading operation.

16. The method of claim 15, further comprising, at least one member of the collection comprising the steps of:
generating a response time-stamp for said container code based upon said response, for at least one of said quay cranes;
receiving a quay time-stamp with said image frame sequence, for at least one of said quay cranes; and
indicating said quay crane for said container code to create a quay crane identification for said container, for at least one of said quay cranes; and
wherein the step sending said container code further comprises at least one member of the collection comprising the steps of:
sending said response time-stamp for said container code to said container inventory management system;
sending said quay time-stamp for said container code to said container inventory management system; and
sending said quay crane identification for said container code to said container inventory management system.

17. The method of claim 15, wherein the step providing said human operator said image frame sequence for said container viewed from said camera on said quay crane, for at least one of said quay cranes, further comprises the steps of:
processing a compressed image frame sequence based upon said container viewed from said camera on said quay crane during said transfer operation to create said image frame sequence; and
presenting said image frame sequence to said human operator.

18. Said compressed image frame sequence and said received compressed sequence as products of the process of claim 17.

19. The method of claim 15, wherein the step of receiving from said human operator said response further comprising at least one member of the collection comprising the steps of:
receiving from said human operator a keyboard response based upon said image frame sequence to create said container code;
receiving from said human operator a pen-based response based upon said image frame sequence to create said container code; and
receiving from said human operator an acoustic response based upon said image frame sequence to create said container code.

20. The method of claim 19, wherein the step receiving from said human operator said acoustic response further comprises the steps of:
collecting from said human operator said acoustic response;
providing said acoustic response to a speech recognition tool; and
receiving from said speech recognition tool said container code.

21. The method of claim 15, wherein the step sending said container code further comprises the steps of:
creating a container update message including said container code for said container; and
sending said container update message to said container inventory management system.

22. Said container update message as a product of the process of claim 21.

23. The method of claim 21, wherein said container update message further includes at least one member of the collection comprising:
an identification of said quay crane,
a response time-stamp based upon said response, and
a quay time-stamp received with said image frame sequence.

24. The method of claim 15, further comprising the step of:
receiving an optical characteristic from an optical characteristic system corresponding to said image frame sequence from said camera on said quay crane, for at least one of said quay cranes;
wherein the step sending said container code further comprises the step of:
sending said optical characteristic for said container to said container inventory management system.

25. The method of claim 24, further comprising, for at least one of said quay cranes, the steps of:
selecting an image frame from said image frame sequence; and
creating an archival item including said image frame and said container code for said container handled by said quay crane and including said optical characteristic.

26. The method of claim 15, for at least one of said quay cranes, further comprising the steps of:
selecting an image frame from said image frame sequence; and
creating an archival item including said image frame and said container code for said container handled by said quay crane.

27. Said archival item as a product of the process of claim 26.

28. The method of claim 26, wherein said archival item further includes at least one member of the collection comprising:
an identification of said quay crane,
a response time-stamp based upon said response, and
a quay time-stamp received with said image frame sequence.

29. An apparatus implementing the method of claim 15, comprising, for each of said steps, means for said step.

30. The apparatus of claim 29, wherein the means implementing one of said steps further comprises at least one computer controlled at least in part by a program system comprising at least one program step residing in a memory accessibly coupled to said computer;
wherein said program step at least partially implements said step;
wherein said computer includes at least one member of a collection comprising an instruction processor, an inferential engine, a neural network, and a finite state machine;
wherein said instruction processor includes at least one instruction processing element and at least one data processing element; wherein each of said data processing elements is controlled by at least one of said instruction processing elements.

31. Said image frame sequence provided to said human operator, said response, and said container code for said container handled by said quay crane, for at least one of said quay cranes, as products of the process of claim 15.

32. The method of claim 15, wherein N is at most 4.

33. The method of claim 15, further comprising, for at least one of said cameras on at least one of said quay cranes, the steps of:
receiving from said human operator a second response based upon said image frame sequence, to create a camera directive for said camera on said quay crane; and
sending said camera directive to said camera on said quay crane to at least partly control said image frame sequence viewed from said camera on said quay crane.

34. The method of claim 33, wherein said camera directive includes at least one member of a camera directive collection comprising a zoom directive and a pan directive;
wherein said zoom directive is a member of a zoom directive collection comprising at least one zoom-in directive, at least one zoom-out directive, and a return-to-standard zoom directive; and
wherein said pan directive is a member of a pan directive collection comprising a pan-left directive, a pan-right directive, a pan-up directive and a pan-down directive.

35. The method of claim 15, further comprising, for at least one of said quay cranes with at least one light directed to said container, the steps of:
receiving from said human operator a third response based upon said image frame sequence, to create a lighting directive for said light on said quay crane; and
sending said lighting directive to said light on said quay crane to at least partly control said image frame sequence viewed from said camera on said quay crane.

36. The method of claim 35, wherein said lighting directive includes at least one member of a lighting directive collection comprising a lights-on directive, a lights-off directive, a raise-lighting directive, and a lower-lighting directive.
